(19) United States
(12) Patent Application Publication
(10) Pub. No.: US 2008/0004766 A1
(43) Pub. Date: Jan. 3, 2008

(54) CONTROL SYSTEM FOR AUTOMOBILES

(76) Inventors: Michele Roberto Alfredo Antonio Gallo, Ancaster (CA); Gilbert Zeneri, North York (CA)

Correspondence Address: BERESKIN AND PARR, 40 KING STREET WEST, BOX 401, TORONTO, ON, M5H 3Y2, CA

(21) Appl. No.: 11/767,703

(22) Filed: Jun. 25, 2007

Related U.S. Application Data
(60) Provisional application No. 60/815,864, filed on Jun. 23, 2006.

(51) Int. Cl. G01M 17/00; G06F 19/00; G06F 7/00

(52) U.S. Cl. 701/29

(57) ABSTRACT

A control and diagnostic system for controlling and diagnosing auxiliary devices in an automobile, the control and diagnostic system comprising: an output terminal for interfacing with and providing control signals to an auxiliary device; an input for receiving control signals from an auxiliary device; a switching device coupled to the output terminal, for alternately providing and preventing the supply of current to the auxiliary device; a fuse coupled to the switching device for limiting the current flowing through the switching device; control circuitry coupled to the input, output and switching device for alternately enabling and disabling each of the input, output and switching device and for providing control signals to the auxiliary device; a switching source for providing control parameters to the control circuitry; and a diagnostic display corresponding to an element that is to be diagnosed, for displaying the status of the element.

### FIELD

The embodiments described herein relate generally to control and diagnostic systems, and more particularly to control and diagnostic systems for use in automobiles.

### BACKGROUND

All automobiles in operation may have their various components replaced with after market components. Such components may be replaced when they are not functioning as required, or to improve performance.

The market for after market components continues to grow and car owners spend increasing amounts of time and money installing these respective components on their automobiles. However, the installation of these components has lead to increased problems with respect to diagnostics, as the diagnostic controllers that are provided with automobiles are not able to control or perform diagnostic tests related to the functioning of these devices.

### SUMMARY

Embodiments described herein relate to a control and diagnostic system for controlling and diagnosing auxiliary devices in an automobile.

In one embodiment, a control and diagnostic system is provided. The control and diagnostic system comprises an output terminal for interfacing with and providing control signals to an auxiliary device; an input for receiving signals from an auxiliary device; a switching device coupled to the output terminal, for alternately providing and preventing the supply of current to the auxiliary device; a fuse coupled to the switching device for limiting the current flowing through the switching device; control circuitry coupled to the input, output and switching device for alternately enabling and disabling each of the input, output and switching device and for providing control signals to the auxiliary device; a switching source for providing control parameters to the control circuitry; and a diagnostic display corresponding to an element that is to be diagnosed, for displaying the status of the element.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of a first exemplary embodiment of an auxiliary device management system;

FIG. 2 is a schematic diagram of the main controller board;

FIG. 3 is a block diagram of an embodiment of the control and diagnostic system;

FIG. 4 is a schematic diagram of an auxiliary module;

FIG. 5 is a schematic diagram of another embodiment of an auxiliary module;

FIG. 6 is a block diagram of a third embodiment of the control and diagnostic system; and

FIG. 7 is a bock diagram of a second exemplary embodiment of an auxiliary device management system incorporating a safety circuit.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

For simplicity and clarity of illustration, where considered some reference numerals are repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The auxiliary device management system 10 that is described herein allows users to install after market components to their automobiles, which may increase performance. The system 10 provides an effective system and method to control the operation of these devices, by monitoring their performance and providing diagnostic indicators to the users regarding their respective operation.

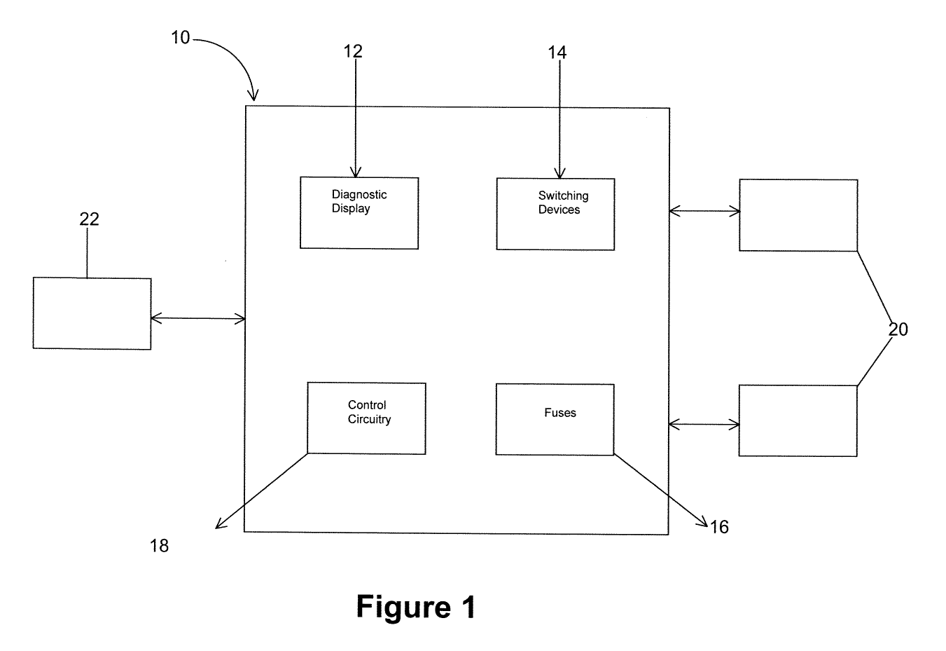

Reference is now made to FIG. 1, which illustrates elements of various exemplary embodiments of an auxiliary device management system 10 comprises one or more diagnostic displays 12, one or more switching devices 14, one or more fuses 16, control circuitry 18, and load protection devices.

The diagnostic displays 12 may comprise any appropriate elements including but not limited to, indicators, and light emitting diodes (LEDS). The diagnostic displays 12 can be used to indicate the states of various components. The states may include, but are not limited to on or off, active or inactive, enabled or disabled, faulty or operational, and functioning properly or malfunctioning. The switching devices 14 may include but are not limited to relays and power transistors. The control circuitry 18 may comprise any appropriate elements including but not limited to resistors, diodes, coils, and capacitors.

The control and diagnostic system 10 also includes input and output terminals. Some of the input and output terminals may be utilized to connect to other devices, including but not limited to, auxiliary devices 20, sensors 22, as well as other control devices (not illustrated), including but not limited to external switches, switch panels, and controllers. The control and diagnostic system 10 may be hardwired to the various diagnostic elements to which it is connected.

The auxiliary devices 20 may include, but are not limited to, fuel pumps, water pumps, fans, motor/engine starter, ignition components, lights, windows, door locks, nitrous, pressurized gases, solenoids, transmission-brake, brake line-lock devices, other auxiliary devices. Auxiliary devices 20 may be any device that may be replaced in an automobile for which a connection with the control and diagnostic system 10 may be made.

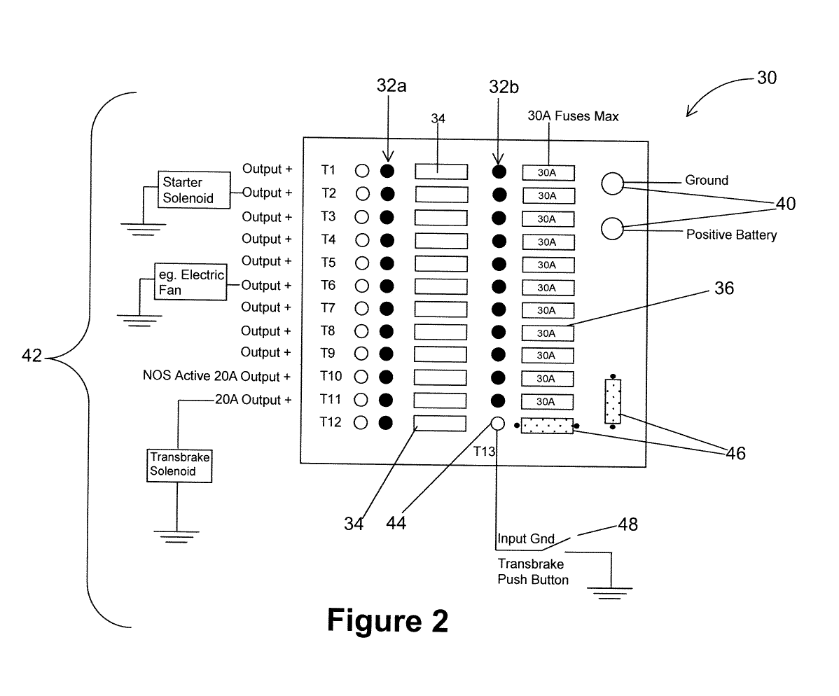

Reference is now made to FIG. 2, which illustrates a schematic diagram of an embodiment of a main controller board 30. Main controller board 30 may comprise all of the control circuitry, switching devices, diagnostic displays, and fuses for controlling the various auxiliary devices to which it is connected in an exemplary embodiment. In an alternative embodiment, other boards may be used in conjunction with the main controller board 30 with regards to the control circuitry, switching devices, diagnostic displays, and fuses. Main controller board 30 comprises a plurality of LEDs 32a and 32b, relays 34, fuses 36, power terminals 40, outputs 42, input terminal 44 and bus connectors 46. The output terminals 42 may be coupled to any appropriate auxiliary device. FIG. 2 for purposes of example, illustrates connections to a starter solenoid, electric fan, nitrous, and a transmission brake solenoid. LEDs 32a indicate the status of one the output terminals 42, where an output terminal 42 has a status output to report. In some embodiments, if the LEDs are on, then this indicates that the output is active and if the LED is off, then this indicates that the output is inactive. In various other embodiments, different colors could be used to indicate various states of the output. Similarly, each LED 32b indicates the status of a fuse. In some embodiments, the color of the LED 32b may be used to indicate the status of the fuse. For example, one color may be used to indicate that a fuse has been blown, and other colors may indicate that the fuse is operational, or multiple LEDs of different colors, where one may be operational at a time, may be used. Power terminals 40 may be connected to any appropriate power source including but not limited to a battery or an alternator (if present). Bus connectors 46 may be used to connect to any appropriate device through a bus communication line.

Input 44 is connected to switch 48, which can be a transmission brake push button switch in an exemplary embodiment. When switch 48 is connected to ground, an appropriate signal is provided at outputs 42 to activate the transmission brake solenoid and activate and deactivate any auxiliary modules. For purposes of this description, the auxiliary modules are described as nitrous modules, which are used in controlled racing environments to bolster the performance of an automobile.

Main controller board 30 may comprise a printed circuit board which may include discrete and integrated components in an exemplary embodiment. These components may include the various elements discussed above in relation to the control and diagnostic elements 10. The various elements of main controller board 30 may be coated or housed in flame, moisture, corrosion, salt, chemicals and vibration-resistant materials.

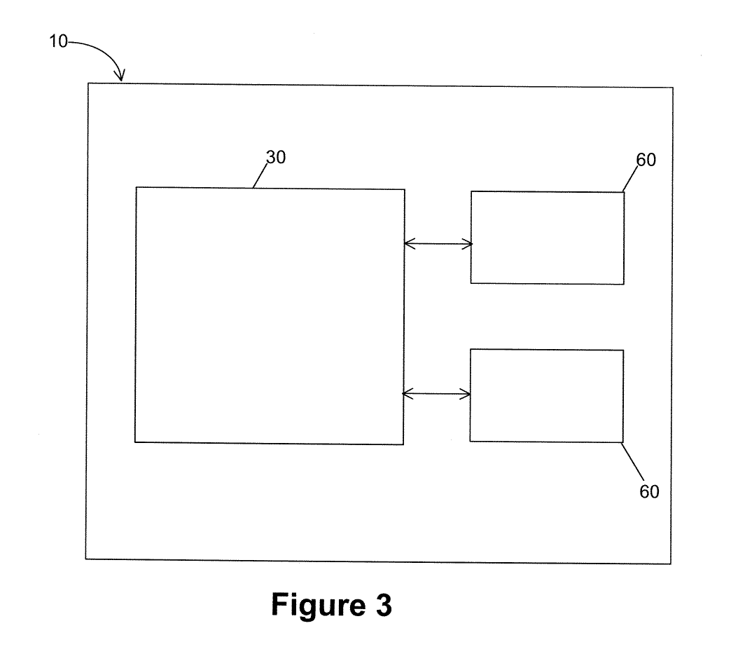

Reference is now made to FIG. 3, which illustrates elements of some embodiments of control and diagnostic system 10. In these embodiments, control and diagnostic system 10 comprises a main controller board 30, which may be the main controller board 30, and one or more auxiliary modules 60. Controller board 30 may interface with one or more auxiliary modules in any appropriate manner, including but not limited to, through bus connectors and a bus communication line, and hardwired connections. Auxiliary modules, in an exemplary embodiment are used in an automobile, and connect to the control and diagnostic system 10. The auxiliary modules when used with the control and diagnosis system provide an effective method by which the driver or any other person may diagnose the operation of the auxiliary modules. This is particularly important where the auxiliary modules are used in high performance controlled environments, as it is important that the driver of any other person responsible for the automobile is able to perform a first initial screen with respect to the operation of any modules that have been added to the automobile.

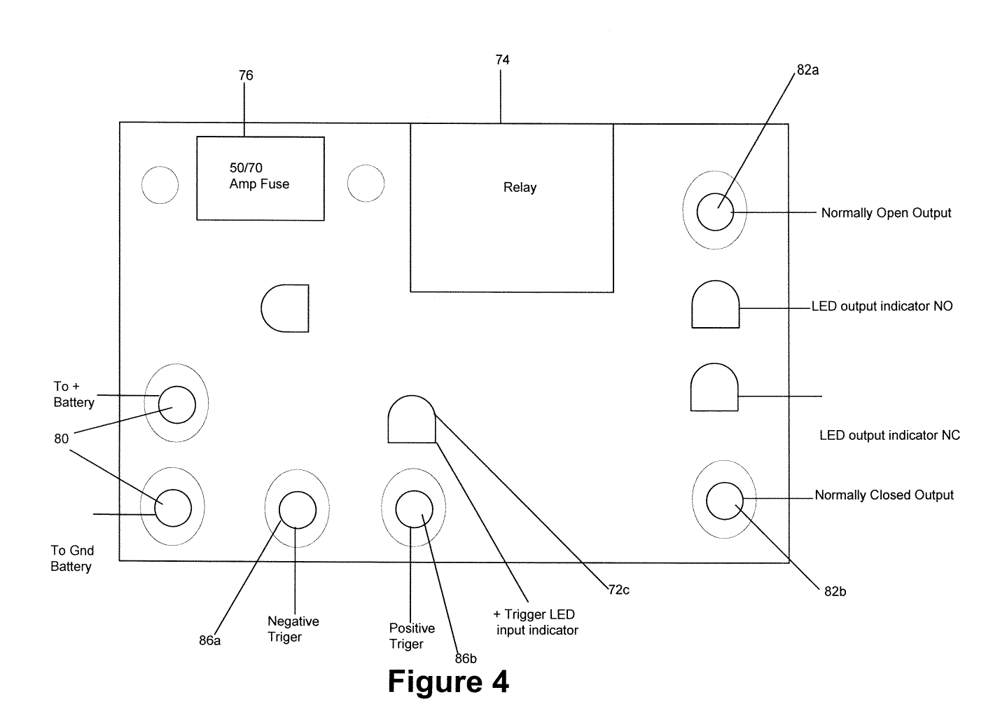

Reference is now made to FIG. 4, which illustrates an exemplary embodiment of an auxiliary module 70 that may be used as the auxiliary module 60 of FIG. 3. Auxiliary module 60 in an exemplary embodiment comprises a plurality of LEDs 72a, 72b, and 72c, a relay 74, a fuse 76, power terminals 80, a normally open output 82a, normally closed output 82b, a negative trigger and a positive trigger 86b.

Power terminals 80 may be connected to any appropriate power source including but not limited to a battery or an alternator (if present). Negative trigger 86a and positive trigger 86b are used to specify whether the relay 74 is triggered on a positive or negative input signal. A negative trigger may be set by connecting negative trigger 86a to the negative terminal of power terminals 80. Similarly, a positive trigger may be set by connecting the positive trigger 86b to the positive terminal of power terminals 80.

In addition, relay 74 may be set to be normally closed or normally open. If relay 74 is normally open, then the normally open output 82a is utilized and if it is normally closed, then terminal 82b is utilized. LEDs 72a indicate whether relay 74 is set to normally open or normally closed.

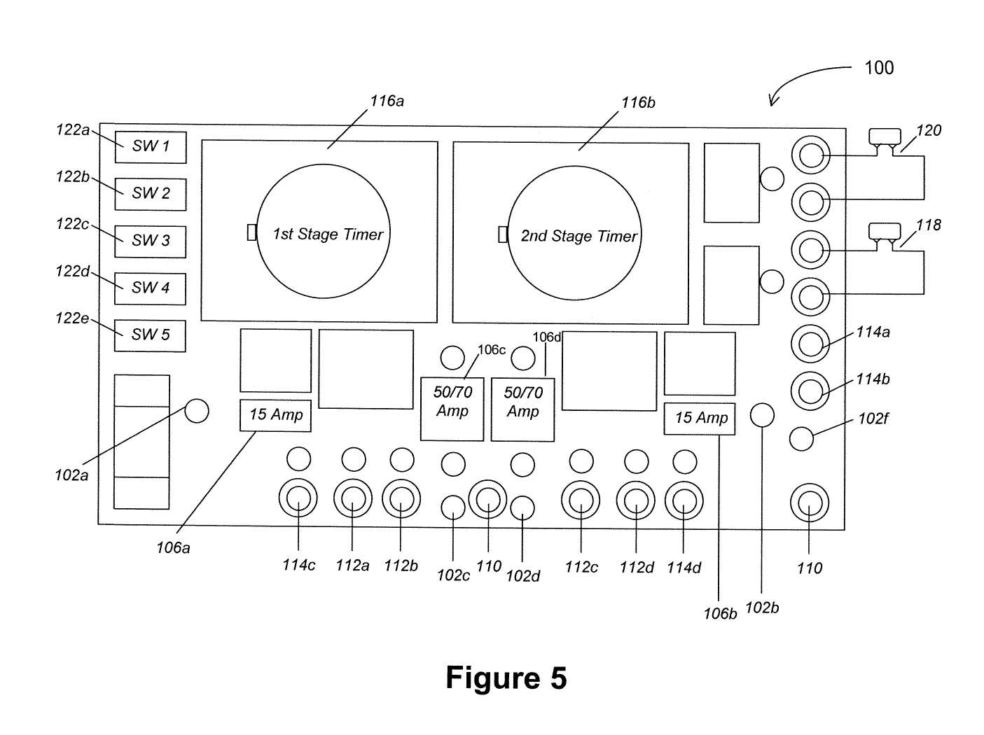

Reference is now made to FIG. 5, which illustrates various other embodiments of auxiliary modules 100, which may be utilized as an auxiliary module 60 in FIG. 4. Auxiliary module 100 is an auxiliary module that may be adapted to interface with a nitrous auxiliary device (not illustrated). However, auxiliary module 100 may also be adapted to interface with other auxiliary devices as well. Auxiliary module 100 comprises a plurality of LEDs 102a to 102f, relays 104 fuses 106a to 106d, power terminal 110, output terminals 112a to 112d, input terminals 114a to 114d, timers 116a and 116b, switches 118a to 118e, an auxiliary input trigger switch 120, and a full throttle input 122.

Auxiliary module 100 may be operated in conjunction with a controller module or in a stand-alone configuration on its own or in conjunction with other auxiliary modules 100 as described below. The Auxiliary module 100 may communicate with a controller, control switch panel, or other auxiliary modules 100 through a bus cable or stand alone wiring.

Fuses 106a and 106b are 15 amp fuses in an exemplary embodiment, while fuses 106c and 106d in an exemplary embodiment are 50 A or 70 A fuses. The amps of the respective fuses have been provided for purposes of an exemplary embodiment. Thus, the use of fuses 106c and 106d allows for a greater supply of current to the nitrous auxiliary device than would be possible if only the main controller board 30 were used.

LEDs 102a to 102d are utilized to indicate the state of the various fuses 106a to 106d. As explained above, in some embodiments, the color of the LED 102a to 102d may be used to indicate the status of the fuse. For example, one color may be used to indicate that the fuse is blown and another color may be may be used to indicate that the fuse is operational. Alternatively, the LEDs may be on to indicate an operational fuse an off to indicate a blown fuse.

Power terminals 120 may be connected to any appropriate power source including but not limited to a battery or an alternator (if present).

Input 114a is a ground or negative trigger input. It may be coupled to an RPM switch, an MSD box or any other appropriate device that provides a ground. This could be used to trigger appropriate signals at specific RPM values.

Input 114b is used to arm or disable the nitrous auxiliary device. This signal may be received from a main controller such as main controller 30 of or another switching device.

Purge input terminals 114c and 114d are utilized to purge the nitrous lines in the vehicle. Each auxiliary module 100 may purge to separate lines. Each nitrous stage has a separate purge circuit this is needed when nitrous is used, nitrous pressures must be equalized independently due to the difference in pressures.

More than one auxiliary module 100 may be coupled together in order to allow for the separate purging and control of more than two nitrous lines. This may be accomplished by sending a positive signal to the inputs 114c and 114d. This positive signal may be supplied by a main controller board or any other appropriate switching device. A positive signal causes purge relays to close the circuit to purge outputs 112a and 112d which are coupled to the nitrous device and cause the device to purge its lines.

Timers 116a and 116b may be utilized for timed operation of a nitrous auxiliary device or other components including but not limited to, transmission, clutch or other gear position activation or any other device that requires time delayed operation. For example, timers 116a and 116b could be used to activate the nitrous device at various time intervals. Timers 116a and 116b may provide various control functions for the auxiliary devices such as pulsed nitrous outputs, in which the nitrous devices are periodically pulsed or steady on operation in which the nitrous devices are continuously operated for a period of time. The parameters by which timers 116a and 116b operate are adjustable depending on the state of the respective switches. Timers 116a and 116b may be implemented as, but are not limited to, mechanical devices or solid state devices.

Input 118 is the full throttle switch, which must be in a closed state for the timers to be operative. This signal may be provided by a controller board, by a separate switch, or any other appropriate switching device.

The auxiliary input trigger 120 is utilized to enable or disable the auxiliary nitrous module 100. The input signal may be provided by a main controller such as main controller 30 or another switching device.

Switches 122a to 122e allow the user to change various parameters as will be explained below. Switches 122a to 122e may be any appropriate switches, including micro and contact switching devices. Switches 122a to 122b may be integrated into the auxiliary module 100.

Switch 122a may be utilized to bypass the auxiliary input 120. The auxiliary input 120 may be bypassed when the auxiliary nitrous module 100 is stacked with another nitrous module 100. As mentioned above, the combination of several auxiliary modules 100 would allow for the separate control of up to four nitrous stages in an exemplary embodiment.

Switch 122b may be utilized to disable or bypass timer 116a. If timer 116a is bypassed then the timer's timer relay is not needed. When timer 116a is bypassed, the first nitrous stage is instantaneously activated upon receipt of appropriate signals in an exemplary embodiment. In contrast, when the timer is active, the nitrous stage is not activated until the timer has completed its count.

Switch 122c may be utilized to bypass the first nitrous stage and thereby leave only the second stage active. In some embodiments, in order for the second nitrous stage to be operated when the first stage is bypassed, switch 122b must be triggered to bypass the first timer 116a. Switch 122d is utilized to bypass the second nitrous stage. Switch 122e is utilized to enable or disable (bypass) the input 114a. When the input is disabled any signal provided to it by a device is ignored by auxiliary module 100.

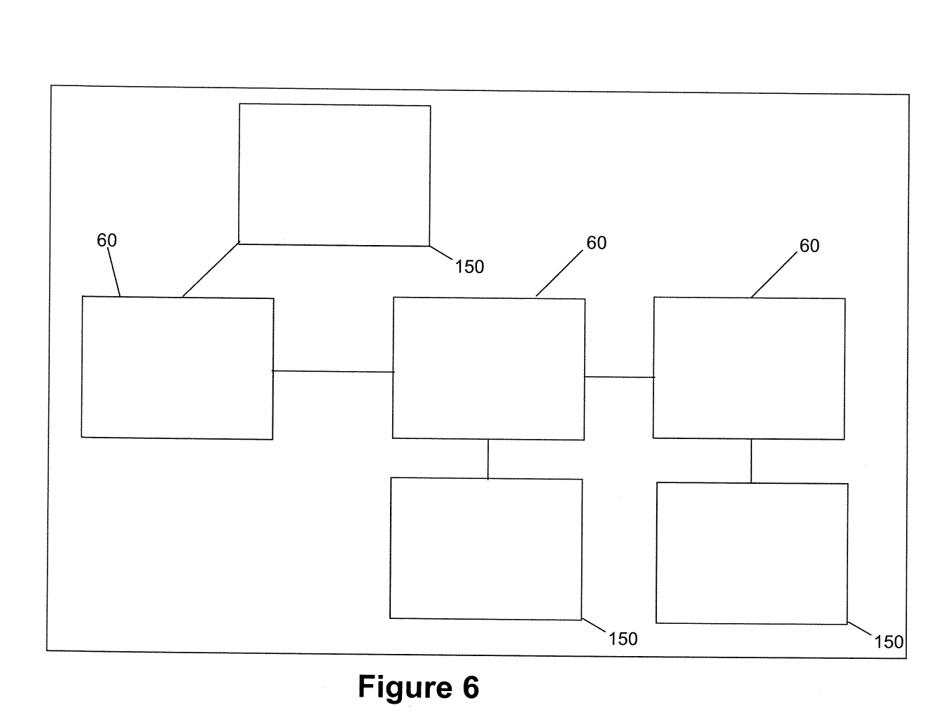

Reference is now made to FIG. 6, which illustrates elements of some embodiments of control and diagnostic system 10. In these embodiments, control and diagnostic system 10 comprises one or more auxiliary devices 60. Auxiliary devices 60 may be, but are not limited to, the auxiliary module 70 of FIG. 4 or the auxiliary module 100 of FIG. 5. In these embodiments auxiliary modules 60 operate in stand-alone operation and are not coupled to a main controller module such as controller module 30 of FIG. 2. In addition, one or more switching devices 150 are connected to the various auxiliary modules 60. Switching devices 150 may be any appropriate device including but not limited to a switch panel, individual switches or other controllers.

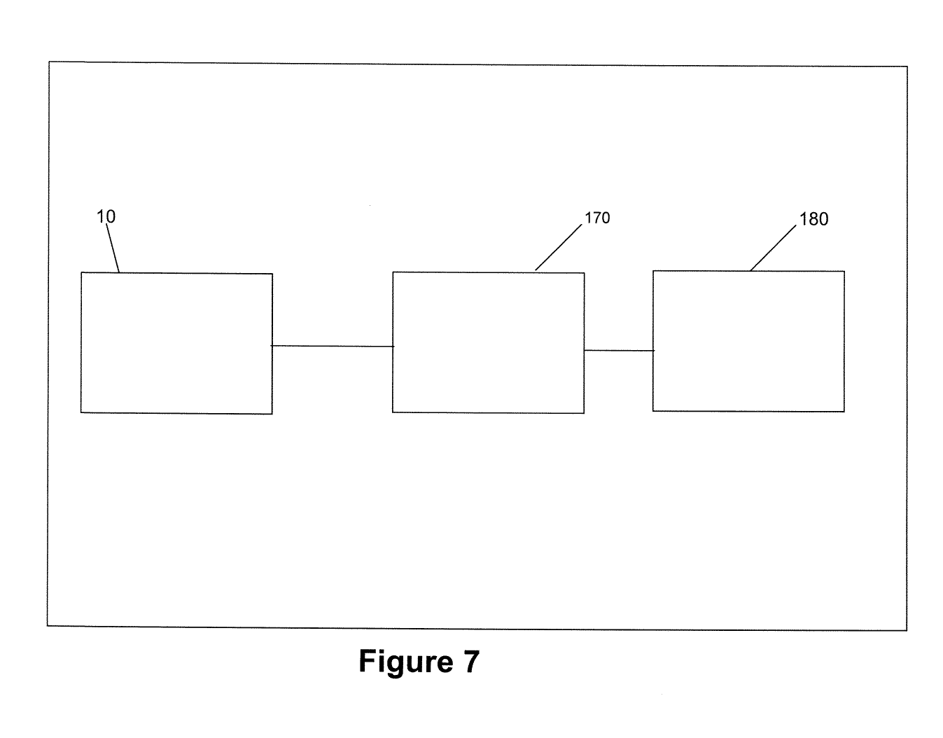

Reference is now made to FIG. 7, which illustrates various embodiments of control and diagnostic system 10. Control and diagnostic system 10 may be coupled to an emergency shutdown circuit 170. Specifically, each element that comprises control and diagnostic system 10 may be coupled to emergency shutdown circuit 170. Emergency shutdown circuit 170 is in turn coupled to other devices such as sensors 180. In appropriate circumstances emergency shutdown circuit 170 may send signals to the various elements of control and diagnostic system 10 to cause all mechanical and electrical functions to be disabled. For example, sensor 180 may be an accelerometer. Emergency shutdown circuit 170 may be configured such that if sensor 180 detects a sudden deceleration, which is indicative a crash, then emergency shutdown circuit 170 transmits appropriate signals to the various elements of control and diagnostic system 10 to cause some or all mechanical and electrical devices to be disable and thereby minimize an fire hazards which may be present.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

We claim:

1. A control and diagnostic system for controlling and diagnosing auxiliary devices in an automobile, the control and diagnostic system comprising:
an output terminal for interfacing with and providing control signals to an auxiliary device;
an input for receiving signals from an auxiliary device;
a switching device coupled to the output terminal, for alternately providing and preventing the supply of current to the auxiliary device;
a fuse coupled to the switching device for limiting the current flowing through the switching device;
control circuitry coupled to the input, output and switching device for alternately enabling and disabling each of the input, output and switching device and for providing control signals to the auxiliary device;
a switching source for providing control parameters to the control circuitry; and
a diagnostic corresponding to an element that is to be diagnosed, for displaying the status of the element.
